(19) United States
(12) Patent Application Publication
(10) Pub. No.: US 2018/0006494 A1
(43) Pub. Date: Jan. 4, 2018

(54) WIRELESS POWER SUPPLY APPARATUS USED FOR AQUARIUM

(71) Applicant: COREMATE TECHNICAL CO., LTD., Taoyuan County (TW)

(72) Inventors: Wilson WONG, TAOYUAN COUNTY (TW); Aster YEH, TAOYUAN COUNTY (TW)

(21) Appl. No.: 15/201,145

(22) Filed: Jul. 1, 2016

(51) Int. Cl. H02J 50/10; F21V 31/00; F21V 23/02; A01K 63/06; H02J 5/00; A01K 63/04; F21W 131/308

(52) U.S. Cl. CPC H02J 50/10; H02J 5/005; F21V 31/005; A01K 63/047; F21V 23/023; A01K 63/06; F21W 2131/308

(57) ABSTRACT

A wireless power supply apparatus used for an aquarium includes a first casing and a second casing. The first casing is provided with a wireless power supply unit and a first retaining member. The second casing is provided with a wireless power receiving unit and a second retaining member. The wireless power supply unit and the wireless power receiving unit are electrically with a power device and a load device respectively, and are mounted to the outer side and the inner side of the aquarium through the first retaining member and the second retaining member respectively. Through the wireless power supply unit to transmit electric energy to the wireless power receiving unit instead of wiring, the present invention is waterproof and can be installed easily to enhance the appearance of the aquarium.

### BACKGROUND OF THE INVENTION

### 1. Field of the Invention

The present invention relates to a wireless power supply apparatus, and more particularly to a wireless power supply apparatus used for an aquarium.

### 2. Description of the Prior Art

Ornamental aquariums are specifically used for raising aquatic creatures and plants. With the improvement of the modern living standard, more and more people beautify their commercial buildings, offices and homes with aquariums. Therefore, the demand of aquariums is increasing, so that companies are actively involved in researching and developing aquarium equipment. In general, an aquarium device is operated through electricity, such as an air pump, an electric light, a heater, a waterwheel, and the like.

An air pump is taken as an example. A conventional air pump can be applied to an aquarium. The air pump comprises a casing. The casing is provided with a pump therein. The pump has an air inlet tube and an air outlet tube. The air inlet tube and the air outlet tube communicate with the pump. The pump is electrically connected with a power socket through a wire. When the aquarium is filled with water, the air pump is mounted in the aquarium and the wire of the air pump is connected with the power socket to actuate the pump to generate negative pressure. The air is guided through the air inlet pipe to enter the pump and then output to the aquarium from the air outlet pipe by means of the negative pressure of the pump.

Besides, an improved air pump used for an aquarium is developed on the market. The structure of this improved air pump is substantially similar to the aforesaid air pump. This air pump is further provided with a rechargeable battery. When the air pump is actuated, the rechargeable battery is charged simultaneously. The air pump can be normally running even if there is an interruption of electricity. However, the air pump still needs a wire to connect the power socket for operation. When the aquarium is provided with additional devices, more wires are increased to influence the appearance of the aquarium. The installation and wiring of the aquarium are also inconvenient. Sometimes, the aquarium may have an electric leakage.

Accordingly, the inventor of the present invention has devoted himself based on his many years of practical experiences to solve these problems.

### SUMMARY OF THE INVENTION

The primary object of the present invention is to provide a wireless power supply apparatus used for an aquarium through a first induction coil of a wireless power supply unit and a second induction coil of a wireless power receiving unit to supply electricity to a load device instead of the wiring in an aquarium. The present invention is waterproof and doesn't have any electric contact exposed and can be installed easily to enhance the appearance of the aquarium.

In order to achieve the aforesaid object, the wireless power supply apparatus used for an aquarium of the present invention comprises a power device, a first casing, a wireless power supply unit, a second casing, a wireless power receiving unit, and a load device. One side of the first casing is provided with at least one first retaining member facing outward. The first casing is mounted to an outer side of the aquarium through the first retaining member. The wireless power supply unit is disposed in the first casing. The wireless power supply unit comprises a first induction coil capable of transforming electric energy into an electromagnetic field. The first induction coil is electrically connected with the power device. One side of the second casing is provided with at least one second retaining member facing outward.

The second casing is mounted to an inner side of the aquarium through the second retaining member. The wireless power receiving unit is disposed in the second casing. The wireless power receiving unit comprises a second induction coil. The second induction coil is totally wrapped with a sealant. The wireless power receiving unit receives the electromagnetic field of the wireless power supply unit through the second induction coil and transforming the electromagnetic field into electric energy. The load device is electrically connected with the second induction coil of the wireless power receiving unit.

### BRIEF DESCRIPTION OF THE DRAWINGS

FIG. 1 is a block diagram of the wireless power supply apparatus of the present invention;

FIG. 2 is a perspective view in accordance with a first embodiment of the present invention;

FIG. 3 is an enlarged schematic view of the first casing and the second casing of the present invention;

FIG. 4 is a schematic view of the first embodiment of the present invention when in use; and

FIG. 5 is a schematic view of a second embodiment of the present invention when in use.

### DETAILED DESCRIPTION OF THE PREFERRED EMBODIMENTS

Embodiments of the present invention will now be described, by way of example only, with reference to the accompanying drawings.

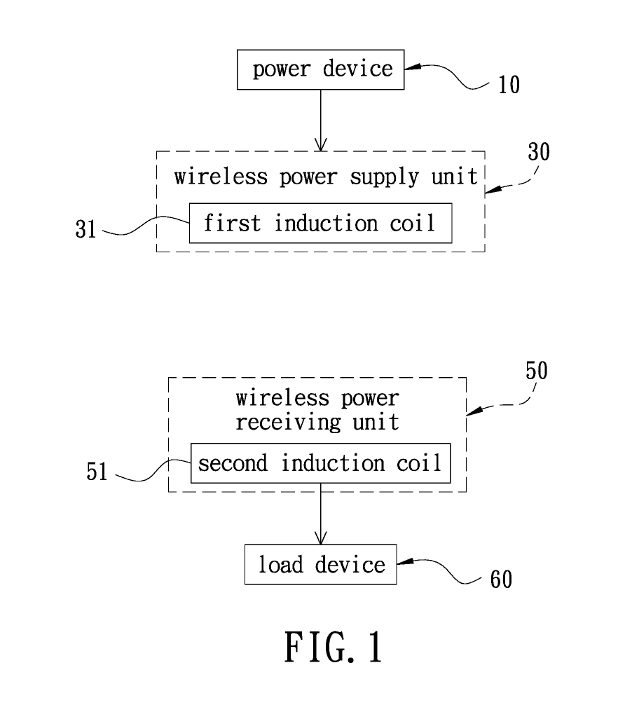

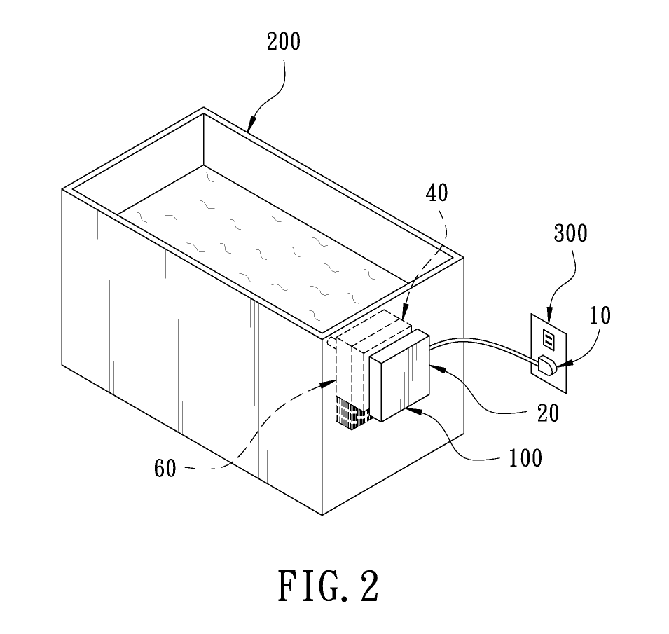

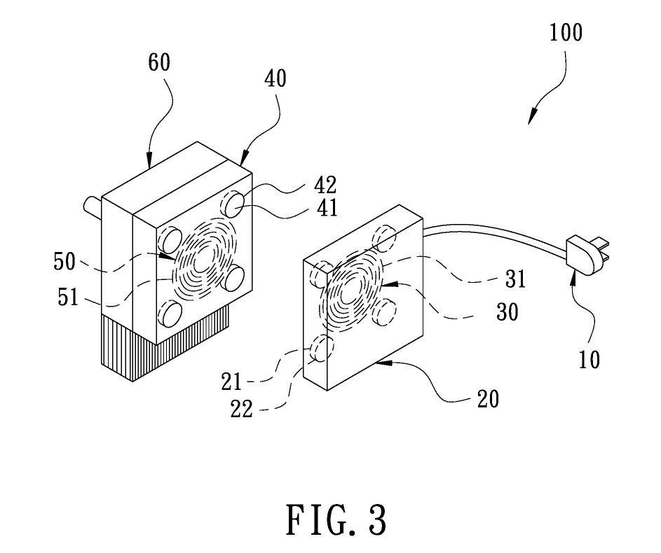

FIG. 1 is a block diagram of the wireless power supply apparatus of the present invention. FIG. 2 is a perspective view in accordance with a first embodiment of the present invention. FIG. 3 is an enlarged schematic view of the first casing and the second casing of the present invention. The present invention discloses a wireless power supply apparatus 100 used for an aquarium 200. The wireless power supply apparatus 100 comprises a power device 10, a first casing 20, a wireless power supply unit 30, a second casing 40, a wireless power receiving unit 50, and a load device 60.

In the first embodiment of the present invention, the power device 10 is a plug. When in use, the power device 10 is plugged in a power socket 300.

One side of the first casing 20 is provided with four first retaining members 21 facing outward. The first casing 20 has four first recesses 22 to receive the first retaining members 21 respectively. The first casing 20 is mounted to an outer side of the aquarium 200 through the first retaining members 21. Each of the first retaining members 21 is a magnet.

The wireless power supply unit 30 is disposed in the first casing 20. The wireless power supply unit 30 comprises a first induction coil 31 capable of transforming electric energy into an electromagnetic field. The first induction coil 31 is electrically connected with the power device 10.

One side of the second casing 40 is provided with four second retaining members 41 facing outward. The second casing 40 has four second recesses 42 to receive the second retaining members 41 respectively. The second casing 40 is mounted to an inner side of the aquarium 200 through the second retaining members 41. Each of the second retaining members 41 is a magnet.

The wireless power receiving unit 50 is disposed in the second casing 40. The wireless power receiving unit 50 comprises a second induction coil 51. The second induction coil 51 is totally wrapped with a sealant to make it watertight. The wireless power receiving unit 50 receives the electromagnetic field of the wireless power supply unit 30 through the second induction coil 51, and transforms the electromagnetic field into electric energy.

The load device 60 is electrically connected with the second induction coil 51 of the wireless power receiving unit 50. In the first embodiment of the present invention, the load device 60 is a pump.

As shown in FIG. 1 to FIG. 4, in the first embodiment of the present invention, the wireless power supply unit 30 and the wireless power receiving unit 50 are coupled to the outer side and the inner side of the aquarium 200 through the magnets of the first casing 20 and the second casing 40, respectively. The power device 10 of the wireless power supply apparatus 100 is electrically connected to the power socket 300. The electric energy from the power socket 300 is supplied to the first induction coil 31 of the wireless power supply unit 30 to generate an electromagnetic field. By the technique of near-field electromagnetic induction, the first induction coil 31 of the wireless power supply unit 30 and the second induction coil 51 the wireless power receiving unit 50 can be coupled by electromagnetic induction. The energy of the first induction coil 31 of the wireless power supply unit 30 can be wirelessly transmitted to the second induction coil 51 the wireless power receiving unit 50 and transformed into electric energy to the load device 60, without a wire.

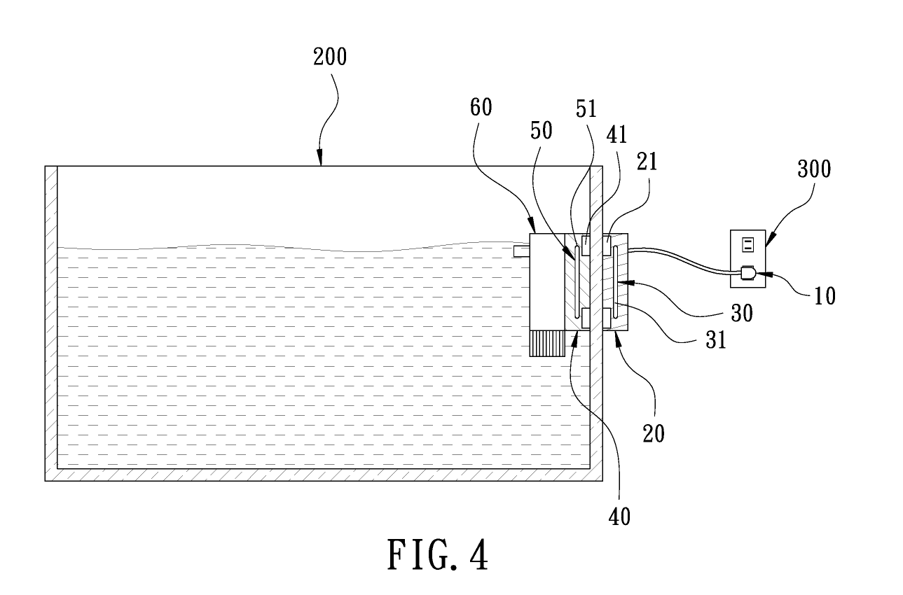

FIG. 3 is an enlarged schematic view of the first casing and the second casing of the present invention. FIG. 4 is a schematic view of the first embodiment of the present invention when in use. The second casing 40, the wireless power receiving unit 50, and the pump are located under the water of the aquarium 200. Because the second induction coil 51 of the wireless power receiving unit 50 is totally wrapped with the sealant, the second induction coil 51 of the wireless power receiving unit 50 is watertight under the water. When the wireless power supply apparatus 100 and the pump are actuated, because the second induction coil 51 of the wireless power receiving unit 50 doesn't have any electric contact exposed, the aquarium 200 won't have an electric leakage to endanger the living creatures in the aquarium 200. Besides, the appearance of the aquarium 200 can be enhanced accordingly.

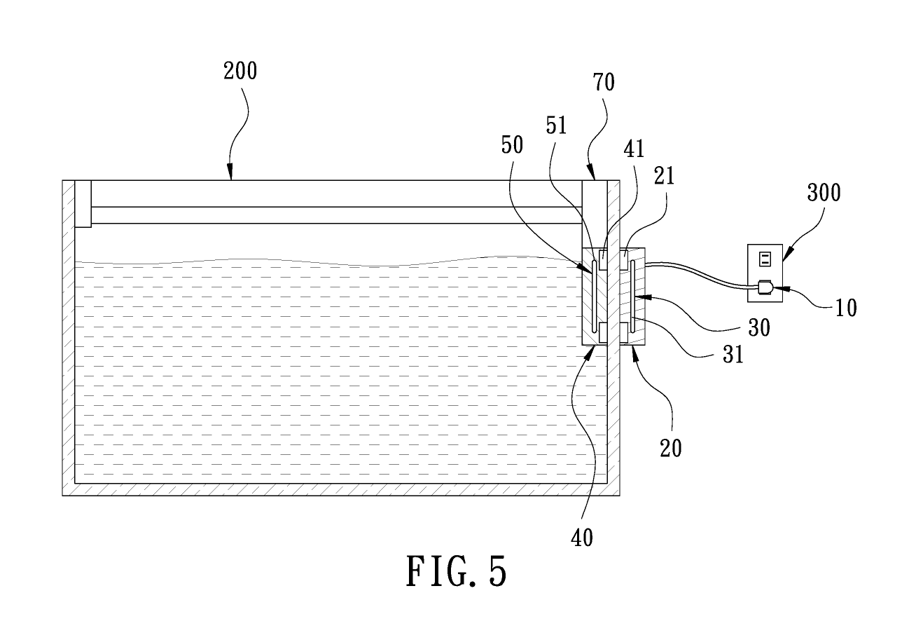

FIG. 5 is a schematic view of a second embodiment of the present invention when in use. In the second embodiment of the present invention, the load device 70 is an electric light. Through the wireless power supply of the wireless power supply unit 30 and the wireless power receiving unit 50, there is no need for the wiring between the wireless power supply unit 30 and the wireless power receiving unit 50 in the aquarium 200, such that the aquarium 200 is more pleasing to the eyes. Furthermore, through the first retaining members 21 of the first casing 20 and the second retaining members 41 of the second casing 40 to attract each other, the present invention can be installed and adjusted easily.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A wireless power supply apparatus used for an aquarium, comprising:
a power device;
a first casing, one side of the first casing being provided with at least one first retaining member facing outward, the first casing being mounted to an outer side of the aquarium through the first retaining member;
a wireless power supply unit disposed in the first casing, the wireless power supply unit comprising a first induction coil capable of transforming electric energy into an electromagnetic field, the first induction coil being electrically connected with the power device;
a second casing, one side of the second casing being provided with at least one second retaining member facing outward, the second casing being mounted to an inner side of the aquarium through the second retaining member;
a wireless power receiving unit disposed in the second casing, the wireless power receiving unit comprising a second induction coil, the second induction coil being wrapped with a sealant, the wireless power receiving unit receiving the electromagnetic field of the wireless power supply unit through the second induction coil and transforming the electromagnetic field into electric energy; and
a load device, the load device being electrically connected with the second induction coil of the wireless power receiving unit;
thereby, the wireless power supply unit getting a power source through the power device, electric energy of the power source being transmitted to the second induction coil of the wireless power receiving unit through the first induction coil of the wireless power supply unit and sent to the load device.

2. The wireless power supply apparatus used for an aquarium as claimed in claim 1, wherein the load device is an electric light.

3. The wireless power supply apparatus used for an aquarium as claimed in claim 1, wherein the load device is a pump.

4. The wireless power supply apparatus used for an aquarium as claimed in claim 1, wherein the first casing has at least one first recess to receive the first retaining member therein.

5. The wireless power supply apparatus used for an aquarium as claimed in claim 4, wherein the first retaining member is a magnet.

6. The wireless power supply apparatus used for an aquarium as claimed in claim 1, wherein the second casing has at least one second recess to receive the second retaining member therein.

7. The wireless power supply apparatus used for an aquarium as claimed in claim 6, wherein the second retaining member is a magnet.
